(19) United States
(12) Patent Application Publication
(10) Pub. No.: US 2005/0198911 A1
(43) Pub. Date: Sep. 15, 2005

(54) Corner key for exterior jamb and sill

(76) Inventors: Eric Baczuk, Kannapolis, NC (US); Matt White, Charlotte, NC (US); Victor T. Massey, Winston-Salem, NC (US)

Correspondence Address: PILLSBURY WINTHROP SHAW PITTMAN, LLP, P.O. BOX 10500, MCLEAN, VA, 22102, US

(21) Appl. No.: 11/075,820

(22) Filed: Mar. 9, 2005

Related U.S. Application Data
(60) Provisional application No. 60/551,365, filed on Mar. 10, 2004.

(51) Int. Cl. E06B 1/04

(52) U.S. Cl. 49/504

(57) ABSTRACT

A sill assembly for a doorjamb assembly includes a sill assembly including a sill base and a threshold. The threshold provides an inclined top surface. A pair of jamb supports are formed in an injection molding process with one of the jamb supports being attached to one end of the sill assembly and the other of the jamb supports being attached to an opposite end of the sill assembly. The jamb supports protrude outwardly from the sill assembly and provide substantially flat jamb support surfaces that engage and support a respective one of the jamb members of a doorjamb assembly. The jamb support surfaces are positioned above the top surface of the threshold such that the jamb supports raise the jamb members above the top surface of the inclined threshold.

### CROSS REFERENCE TO RELATED APPLICATION

This application claims priority to U.S. Provisional Application No. 60/551,365, filed on Mar. 10, 2004, the entire contents of which is incorporated by reference.

### BACKGROUND OF THE INVENTION

1. Field of the Invention

The present invention relates to sill assemblies for use in door jam assemblies. In particular, the present invention relates to molded jamb supports for a sill assembly.

2. Description of Related Art

Known threshold and door sill assemblies are typically placed against the floor and mounted between the lower ends of vertically extending jamb members of a doorjamb assembly. This arrangement allows the lower ends of the jamb members to contact the floor, thereby exposing the end grain of the jamb members to moisture that can lead to rot.

Others have attempted to reduce exposure to moisture by forming the lower portion of the doorjamb from a moisture, decay and insect resistant material. U.S. Pat. Nos. 5,661,943, 5,873,209, 5,950,391 and 6,122,882 to Hagel disclose door frames having integrally formed or joined moisture, decay and insect resistant components secured to the end of a wooden frame. A finger joint integrally joins the components together. This type of integral connection has been shown to be undesirable because of the expansion and contraction of these dissimilar components when exposed to moisture, heat and other elements. Furthermore, this arrangement requires complex cuts be made in the end of the frame to permit mounting to a sill assembly.

The present invention provides numerous improvements over known threshold and door sill assemblies. The jamb supports provide a low cost solution that simplify the manufacture and assembly process by eliminating complex cutting of the wood jamb members and undesirable integrally joined and formed connections associated with the prior art devices. Furthermore, the jamb supports can reduce exposure of the end grain of the jamb members to moisture and enhance rot prevention.

### SUMMARY OF THE INVENTION

One aspect of the invention relates to a sill assembly that includes injection molded jamb supports that can be secured to the sill assembly. This aspect of the invention provides a sill assembly for a doorjamb assembly. The doorjamb assembly includes a pair of vertically extending jamb members, a header structure, and at least one door. The sill assembly includes a sill assembly including a sill base and a threshold connected to the sill base. The threshold provides an inclined top surface. A pair of molded jamb supports can be formed in an injection molding process. One of the jamb supports is attached to one end of the sill assembly and the other of the jamb supports is attached to an opposite end of the sill assembly. The jamb supports protrude outwardly from the sill assembly and provide substantially flat jamb support surfaces that engage and support a respective one of the jamb members. The jamb supports are configured such that the jamb supports can be used in connection with both inwardly and outwardly swing doors. The jamb support surfaces are positioned above the top surface of the threshold such that the jamb supports raise the jamb members above the top surface of the inclined threshold whereby the jamb members are not in contact with any water that is standing or draining off the top surface, which can reduce rot. Furthermore, the jamb supports permit the jamb assembly to be easily configured for any size door opening without the need for complex cutting of the jamb.

Another aspect of the invention relates to a jamb support assembly for attachment to opposite ends of a door sill assembly for a doorjamb assembly. The jamb support assembly includes a pair of jamb supports that can be formed in an injection molding process. One of the jamb supports is attached to one end of the sill assembly and the other of the jamb supports is attached to an opposite end of the sill assembly. The jamb supports protrude outwardly from the sill assembly and provide substantially flat jamb support surfaces that engage and support a respective one of the jamb members. The jamb support surfaces are positioned above the sill assembly such that the jamb supports raise the jamb members above the sill assembly whereby the jamb members are not in contact with any water that is standing or draining off the sill assembly. The jamb supports can include jamb support extensions, which can be secured to the jamb supports. The jamb support extensions can be used to accommodate larger jambs.

Other aspects, features, and advantages of this invention will become apparent from the following detailed description when taken in conjunction with the accompanying drawings, which are a part of this disclosure and which illustrate, by way of example, the principles of this invention.

### BRIEF DESCRIPTION OF THE DRAWINGS

The accompanying drawings facilitate an understanding of the various embodiments of this invention. In such drawings:

FIG. 1 is a front view of an embodiment of a doorjamb assembly incorporating a sill assembly constructed in accordance with an embodiment of the invention;

FIG. 2 is a perspective view of the sill assembly with jamb supports constructed in accordance with an embodiment of the invention;

FIG. 3 is an exploded view of the sill assembly shown in FIG. 2;

FIG. 4 is a right front side perspective view of a jamb support of the threshold and door sill assembly shown in FIG. 2;

FIG. 5 is a left rear side perspective view of a jamb support shown in FIG. 4;

FIG. 6 is a right side view of the jamb support shown in FIG. 4;

FIG. 7 is a bottom view of the jamb support shown in FIG. 4;

FIG. 8 is a left side view of the jamb support shown in FIG. 4;

FIG. 9 is a top view of the jamb support shown in FIG. 4;

FIG. 10 is a front side view of the jamb support shown in FIG. 4;

FIG. 11 is an enlarged top view of the jamb support shown in FIG. 9;

FIG. 12 is a cross-sectional view through line 12-12 of FIG. 9;

FIG. 13 is a perspective view of the jamb support shown in FIG. 4 with optional jamb and sill sealing gaskets;

FIG. 14 is a top view of the jamb sealing gasket shown in FIG. 13;

FIG. 15 is a end view of the jamb sealing gasket shown in FIG. 14;

FIG. 16 is a side view of the sill sealing gasket shown in FIG. 13;

FIG. 17 is a end view of the sill sealing gasket shown in FIG. 16;

FIG. 18 is a right front side perspective view of an embodiment of a jamb support extension in accordance with the invention;

FIG. 19 is a left rear side perspective view of the jamb support extension shown in FIG. 18;

FIG. 20 is a right side view of the jamb support extension shown in FIG. 18;

FIG. 21 is a bottom view of the jamb support extension shown in FIG. 18;

FIG. 22 is a left side view of the jamb support extension shown in FIG. 18;

FIG. 23 is a cross-sectional view through line 23-23 of FIG. 21;

FIG. 24 is an enlarged bottom view of the jamb support extension shown in FIG. 21;

FIG. 25 is another enlarged bottom view of the jamb support extension shown in FIG. 21;

FIG. 26 is a left rear perspective view of another embodiment of a jamb support extension;

FIG. 27 is a right front perspective view of the jamb support extension shown in FIG. 26;

FIG. 28 is a left side view of the jamb support extension shown in FIG. 27;

FIG. 29 is a bottom view of the jamb support extension shown in FIG. 27;

FIG. 30 is a right side view of the jamb support extension shown in FIG. 27;

FIG. 31 is a cross-sectional view through line 31-31 of FIG. 29;

FIG. 32 is an enlarged bottom view of the jamb support extension shown in FIG. 29;

FIG. 33 is another enlarged bottom view of the jamb support extension shown in FIG. 29;

FIG. 34 is a perspective view of the jamb support extension shown in FIG. 18 with jamb and sill sealing gaskets;

FIG. 35 is a front view of the jamb sealing gasket shown in FIG. 34;

FIG. 36 is a side view of the jamb sealing gasket shown in FIG. 35;

FIG. 37 is a front view of the sill sealing gasket shown in FIG. 34;

FIG. 38 is a side view of the sill sealing gasket shown in FIG. 37;

FIG. 39 is a perspective view of the jamb support extension shown in FIG. 26 with jamb and sill sealing gaskets;

FIG. 40 is a front view of the jamb sealing gasket shown in FIG. 39;

FIG. 41 is a side view of the jamb sealing gasket shown in FIG. 40;

FIG. 42 is a front view of the sill sealing gasket shown in FIG. 39;

FIG. 43 is a side view of the sill sealing gasket shown in FIG. 42;

FIG. 44 is perspective view of the jamb support shown in FIG. 4 aligned with the jamb support extension shown in FIG. 26 with jamb and sill sealing gaskets;

FIG. 45 is a perspective view of the sill assembly shown in FIG. 2 with the jam support extension shown in FIG. 18 aligned with an associated jam support;

FIG. 46 is a perspective view of the sill assembly shown in FIG. 2 with the jam support extension shown in FIG. 18 interlocked with an associated jam support; and

FIG. 47 is a perspective view of a jamb support in accordance with the present invention for use in a sill assembly having an outwardly swinging door.

### DETAILED DESCRIPTION OF ILLUSTRATED EMBODIMENTS

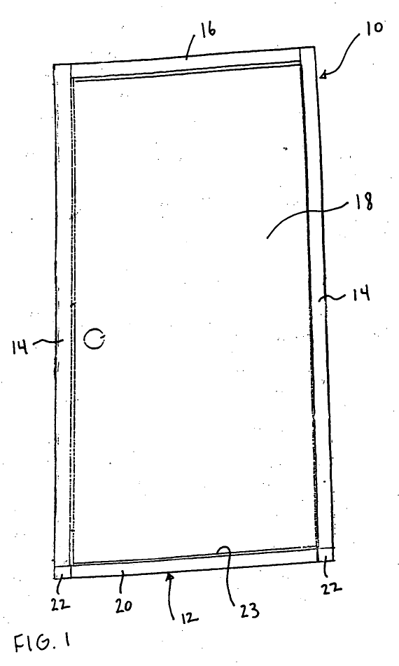

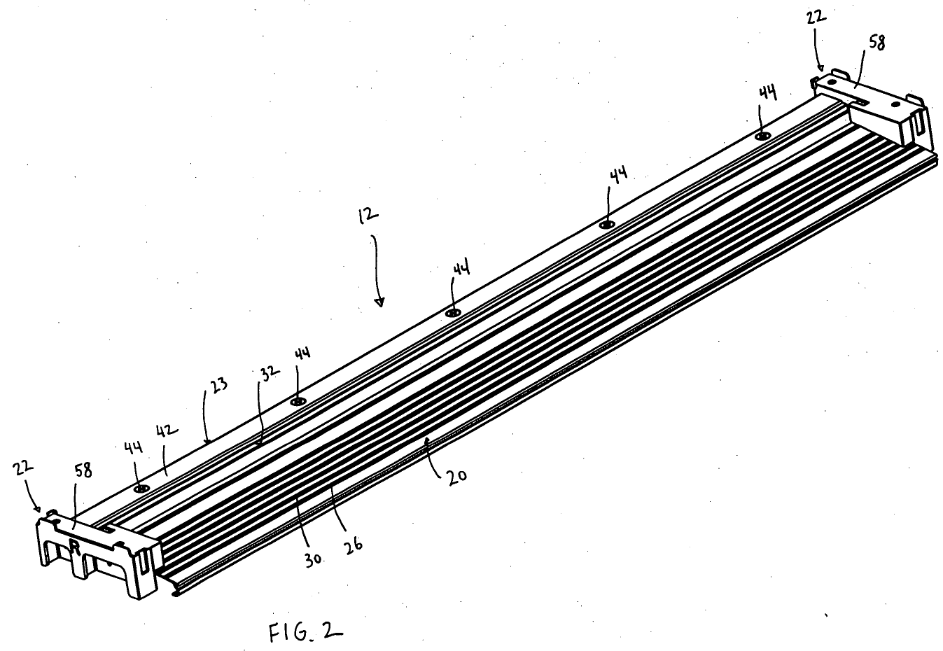

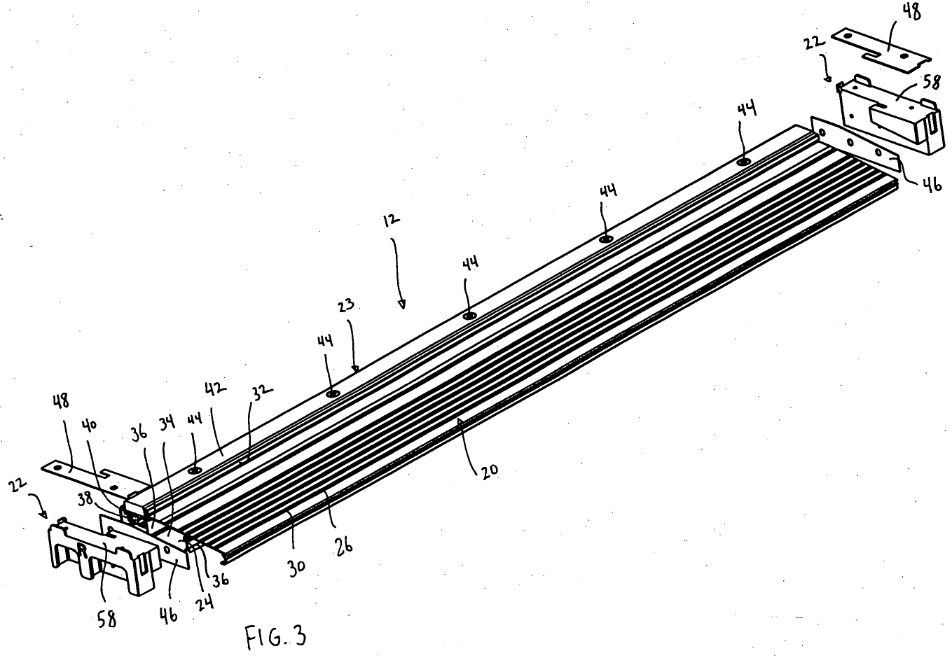

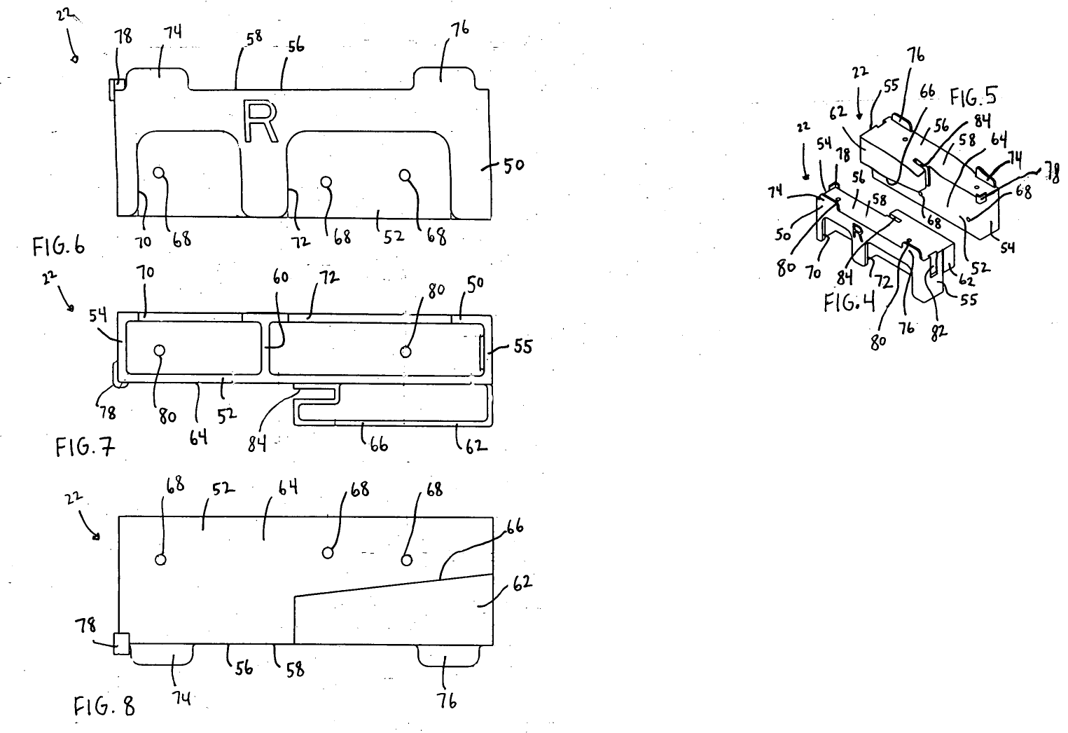

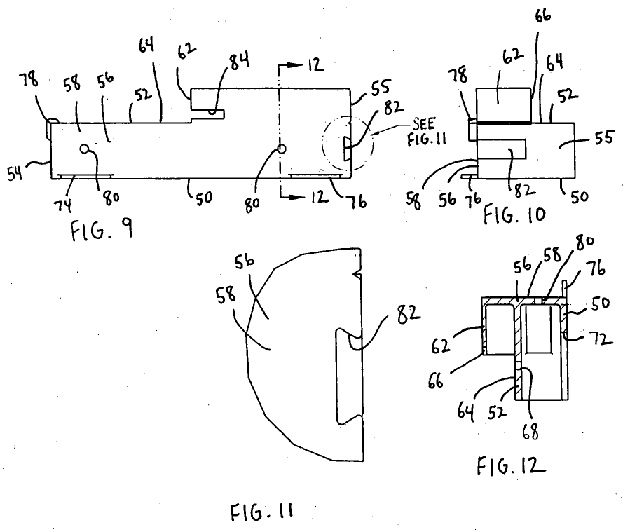

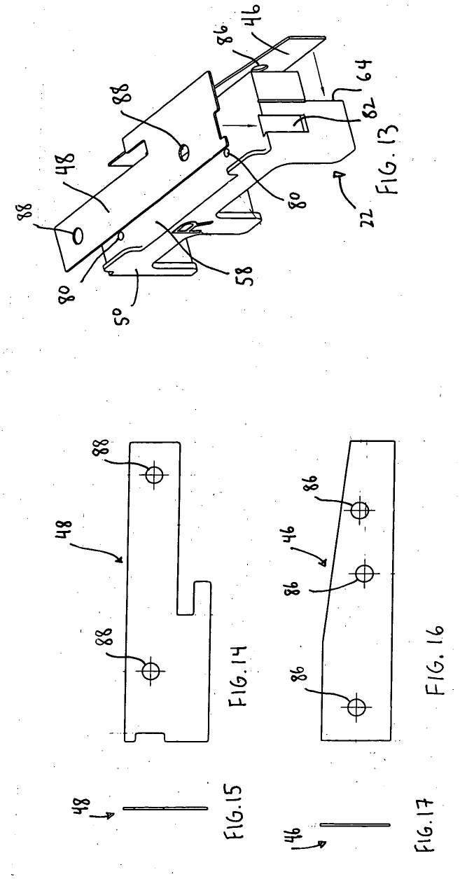

FIG. 1 illustrates a doorjamb assembly 10 incorporating a sill assembly 12 constructed according to an embodiment of the present invention. The doorjamb assembly 10 includes a pair of vertically extending horizontally spaced jamb members 14, which are typically formed from wood, a horizontally extending header structure 16, which is also typically formed from wood, and at least one door 18. The sill assembly 12 includes an elongated sill assembly 20 with jamb supports 22 attached at opposing ends thereof that are connected to lower ends of the pair of vertically extending jamb members 14. The pair of jamb members 14, the header structure 16, and the threshold and door sill assembly 12 form a generally rectangular door jamb opening within which the at least one door 18 is disposed.

The sill assembly 12 is not limited to use with the specific configuration of door jamb assembly shown and other various configurations are contemplated, for example, a door jamb assembly may include a pair of doors, sliding door panel, a combination of fixed and movable door panels and any combination of side panels including side panels disposed on one or both sides of the door. To accommodate the placement and support of side panels, the door jamb assembly may include one or more vertically extending mullions, which are connected at upper ends thereof to the header structure and at lower ends thereof to the sill assembly 12 through a mullion boot assembly. Various arrangements and components are disclosed, for example, in U.S. Patent application Ser. No. 10/673,639, entitled “Adjustable Rail Assembly For Exterior Door Sill Assembly And Components For The Same,” the disclosure of which is incorporated herein specifically by reference.

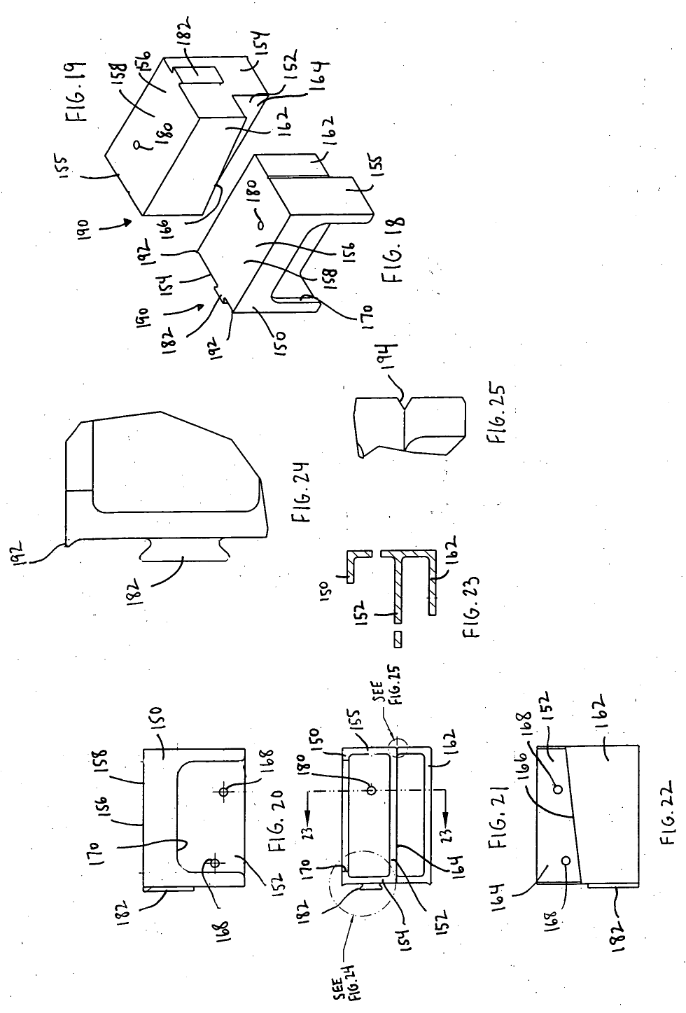

As shown in FIG. 2, the sill assembly 12 includes a sill assembly 20, a pair of jamb supports 22 connected to opposing ends of the sill assembly 20, and a rail assembly 23 adjustably secured to the sill assembly 20. The pair of jamb supports 22 raise the jamb members 14 off the floor to limit exposure to moisture that can lead to rot, as will be further discussed below. The jamb supports simplify the assembly of the jamb assembly by eliminating the need for complex cut downs. Furthermore, the jamb assembly 10 can be easily configured to any size application with one simple straight cut.

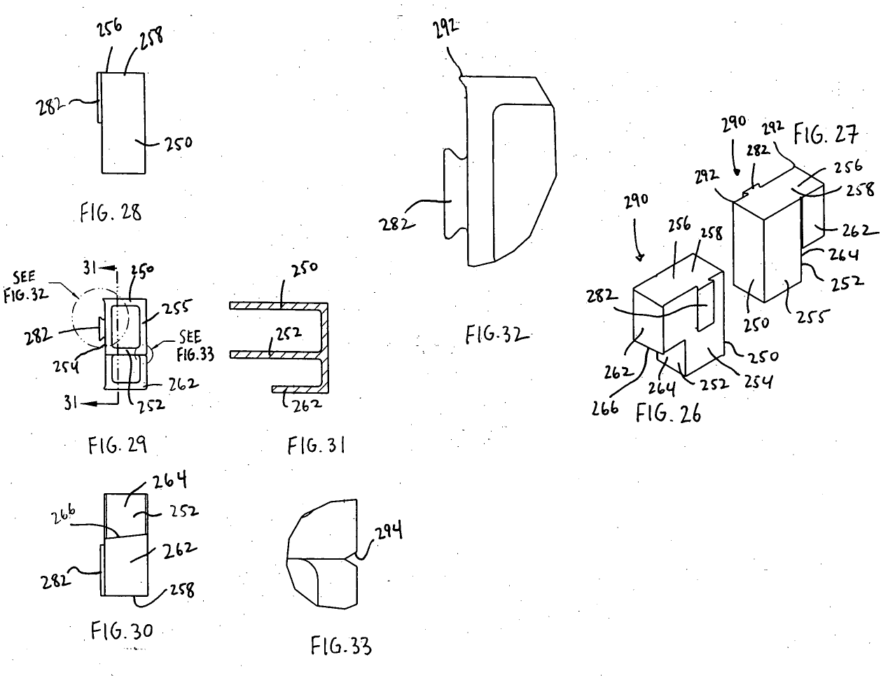

As best shown in FIG. 3, the sill assembly 20 includes a sill base 24 and an inclined threshold 26. The inclined threshold 26 includes an inclined top surface 30 that extends rearwardly from a forward edge to an upwardly extending lip structure 32. The upwardly extending lip structure 32 projects above the inclined top surface 30. The threshold 26 is preferably formed as a one-piece extrusion from aluminum or other suitable material. However, it is also contemplated that the threshold 26 may by formed from plastic or fiberglass.

It is contemplated that the threshold 26 can be either a threshold for a low profile sill assembly or a threshold for a high profile sill assembly. Additionally, the threshold 26 can have an increased width to permit wheelchair use.

The sill base 24 is connected to the threshold 26. The sill base 24 includes a bottom wall 34 and a plurality of transverse reinforcing walls 36 that increase the overall strength and stability of the sill base 24.

The lip structure 32 of the threshold 26 forms one side of a channel 38 that extends along the length of the sill base 24. An opposite side of the channel 38 is formed from an upwardly extending portion 40 provided on the sill base 24.

The rail assembly 23 is secured to the sill assembly 20 to close or eliminate any gap between the sill assembly 20 and the bottom of the door 18. The height of the rail assembly 23 may be adjusted to ensure a good seal with the sweep on the bottom of the door 18. While the present invention is illustrated with an adjustable rail assembly 23, any number of components can be used with the sill assembly 20 including but not limited to fixed rail assemblies, mullion boots, sidelite spacers, astragals, etc.

Specifically, the rail assembly 23 includes a rail member 42 that is received within the channel 38. The rail member 23 is secured within the channel 38 by a plurality of fasteners 44 that extend through tapped holes provided in the sill base 24. Rotation of the fasteners 44 with respect to the sill base 24 can raise and lower the rail member 42 with respect to the sill assembly 20.

The jamb supports 22 (also referred to as corner keys) are formed separately from the sill assembly 20 in an injection molding process and then attached thereto, e.g., by fasteners, including but not limited to staples, screws, nails or a suitable adhesive. Specifically, one of the jamb supports 22 is attached on one end of the sill base 24 and the other of the jamb supports 22 is attached on the opposite end of the sill base 24. Left and right oriented jamb supports 22 are provided to correspond with the right and left hand side of the sill assembly 20. The jamb supports 22 protrude outwardly from the sill base 24 for engaging and supporting respective jamb members 14. Sealing gaskets 46, 48 are provided between the jamb supports 22 and each of the sill assembly 20 and the jamb members 14, respectively, as will be further discussed.

The pair of jamb supports 22 are mirror images of one another. That is, one of the jamb supports 22 is specifically arranged for engaging the left end of the sill base 24 and the respective jamb member 14, and the other jamb support 22 is specifically arranged for engaging the right end of the sill base 24 and the opposite jamb member 14. Because the jamb supports 22 are similar to one another, an understanding of one will suffice for an understanding of both.

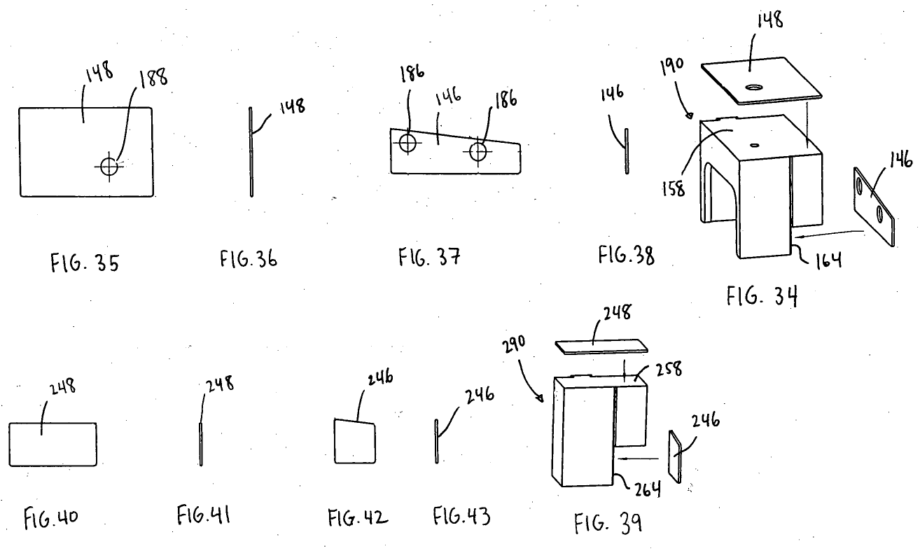

The jamb supports 22 will now be described in greater detail. The vertically extending jamb members 14 are connected to the sill assembly 20 by directly securing the vertically extending jamb members 14 to the jamb supports 22 attached to the sill assembly 20. The jamb support 22 can be secured to the jamb member 14 by a suitable fastener including staples, screws, nails or other suitable fasteners. As shown in FIGS. 4-12, each jamb support 22 includes an outer side wall 50, an inner side wall 52, and a connecting walls 54, 55 that interconnect the outer and inner side walls 50, 52. The walls 50, 52, 54, 55 support a base wall 56 that provides a substantially flat jamb support 58 surface upon which the corresponding vertically extending jamb member 14 rests. A reinforcing wall 60 extends between the outer and inner side walls 50, 52 to add rigidity to the jamb support 22. Also, an extension portion 62 extends outwardly from the inner side wall 52 to support a portion of the base wall 56 and jamb support surface 58 thereof. The extension portion 62 is configured to extend above the threshold 26. The outer side wall 50 and the reinforcing wall 60 provide additional reinforcement against twisting forces.

The inner side wall 52 of each jamb support 22 is structured to cover an open end of the sill assembly 20. The fasteners for securing the jamb support 22 to the sill assembly 20 extend through this side wall 52. Specifically, the inner side wall 52 includes a sill engaging surface 64 that engages the sill assembly 20. Also, as best shown in FIGS. 2, 5, and 8, lower edges 66 of the connecting portion 62 are suitably angled so as to accommodate the incline of the inclined threshold 26. The inner side wall 52 is attached to the sill assembly 20 by staples or by inserting fasteners through openings 68 formed through the sill engaging surface 64, e.g., three openings, and into corresponding openings provided in the sill assembly 20. Accordingly, the sill base 24 and/or the inclined threshold 26 may provide one or more screw bosses for securing the jamb supports 22 by receiving a suitable fastener therein.

As best shown in FIGS. 6 and 12, the outer side wall 50 provides two large openings 70, 72 that allow easy access to the openings 68 in the inner side wall 52 for the purpose of inserting fasteners therethrough and into the sill assembly 20, e.g., via a screwdriver or other suitable tool (e.g., a stapler). Specifically, the outer side wall 50 has one opening 70 that extends from one connecting wall 54 to the reinforcing wall 60, and another opening 72 that extends from the reinforcing wall 60 to the other connecting wall 55. A single opening may be provided.

The jamb support surface 58 includes a plurality of upwardly extending support flanges that are structured to engage the corresponding jamb member 14 and prevent lateral movement of the same on the jamb support 22. In the illustrated embodiment, a first rib 74 extends upwardly from an edge of the support surface 58 adjacent the outer side wall 50 and a second rib 76 is laterally spaced from the first rib 74 along the same edge. Opposite the first rib 74 is a corner rib 78 that extends upwardly from edges of the support surface 58 adjacent the inner side wall 52 and connecting wall 54. However, other support flange arrangements are contemplated. The corner rib 78 functions as a locating device to maintain the necessary margin between the jamb members 14 and the door 18.

The jamb supports 22 are secured to respective jamb members 14 by a plurality of fasteners. In the illustrated embodiment, a pair of openings 80 are provided through the support surface 58 that allow fasteners to extend therethrough and into the respective jamb member 14. Screws, staples or a suitable adhesive may be used to secure the support 22 to the member 14.

The jamb supports 22 also have an interlocking structure 82 formed therewith that allows the jam supports 22 to interlock with a jam support extension, as will be further discussed.

Additionally, the jamb supports 22 each include a notch 84 through a portion of the support surface 58 and associated connecting portion 62. The notch 84 is suitably sized so as to accept a weatherstrip therein for sealing purposes.

As shown in FIGS. 3 and 13, sealing gaskets 46, 48 are provided between the jamb supports 22 and each of the sill assembly 20 and the jamb members 14, respectively, for sealing purposes. Specifically, a sill sealing gasket 46 is provided between the jamb support 22 and the respective end of the sill assembly 20 and a jamb sealing gasket 48 is provided between the jamb support 22 and the respective jamb member 14. As shown in FIGS. 16 and 17, the sill sealing gasket 46 has a shape that corresponds to a shape of the sill engaging surface 64 of the inner side wall 52. Also, the sill sealing gasket 46 has fastener receiving openings 86 therethrough, e.g., three openings, that align with the openings 68 formed through the sill engaging surface 64. As shown in FIGS. 14 and 15, the jamb sealing gasket 48 has a shape that corresponds to a shape of the jamb support surface 58 of the base wall 56. Also, the jamb sealing gasket 48 has fastener receiving openings 88 therethrough, e.g., two openings, that align with the openings 80 formed through the jamb support surface 58. The gaskets 46, 48 may be secured in place when of the jamb support 22 is secured to the jamb member 14 and the sill assembly 20. Further, the gaskets 46, 48 may be constructed of any suitable sealing material, e.g., closed cell polyethylene.

When attached to the sill assembly 20, the jamb supports 22 raise the jamb members 14 above the inclined top surface 30 of the threshold 26 such that the jamb members 14 are not in contact with any water that is standing or draining off the top surface 30. This arrangement can reduce exposure of the end grain of the jamb members 14 to moisture and enhances rot prevention. The jamb supports 22 eliminate the need for complex cuts on the jamb member 14 when cutting the jamb member 14 is cut to a desired size. A single straight cut is only needed to cut the jamb member. As such, a jamb member can easily be formed to any desired size. The jam supports 22 also minimize damage to the bottom of the jamb members 14 during transportation. The jamb support 22 can be first attached to either the sill assembly 20 or to the jamb member 14.

Another advantage of the jamb supports 22 is that they eliminate a critical machining operation. That is, the jamb members 22 only need a square cut on the bottom thereof in order to accommodate the jamb supports 22. This simplifies modifications for shorter doors and improves quality control.

The jamb supports 22 are preferably formed of a synthetic material. It is noted that a synthetic material is preferable, since this type of material is generally resistant to decay or other degradation. For example, water cannot travel up the jamb supports 22 and into the jamb members 14 to cause rot.

FIGS. 18-25 illustrate an embodiment of a jamb support extension 190 that may be connected with an associated jamb support 22. The jamb support extension 190 allows the sill assembly 20 to accommodate wider door jambs 14 and/or wider thresholds 26. The jamb support extension 190 is structured such that it may be connected with a previously assembled jamb support 22 and sill assembly 20.

Each jamb support extension 190 includes an outer side wall 150, an inner side wall 152, and connecting walls 154, 155 that interconnect the outer and inner side walls 150, 152. The walls 150, 152, 154, 155 support a base wall 156 that provides a substantially flat jamb support surface 158 upon which the corresponding vertically extending jamb member 14 rests. In use, the jamb support surface 158 of the jamb support extension 190 is substantially flush with the jamb support surface 58 of the jamb support 22. Also, a connecting portion 162 extends outwardly from the inner side wall 152 to support a portion of the base wall 156 and support surface 158 thereof.

The inner side wall 152 of each jamb support extension 190 is structured to cover an extended open end of the sill assembly 20. Specifically, the inner side wall 152 includes a sill engaging surface 164 that engages the sill assembly 20. Also, as best shown in FIGS. 19 and 22, lower edges 166 of the connecting portion 162 are suitably angled so as to accommodate the incline of the inclined threshold 26. The inner side wall 152 is attached to the sill assembly 20 by inserting fasteners through openings 168 formed through the sill engaging surface 164, e.g., two openings, and into corresponding openings provided in the sill assembly 20. Accordingly, the sill base 24 and/or the inclined threshold 26 may provide one or more screw bosses for securing the jamb support extensions 190 by receiving a suitable fastener therein.

As best shown in FIGS. 18 and 20, the outer side wall 150 provides a large opening 170 that allow easy access to the openings 168 in the inner side wall 152 for the purpose of inserting fasteners therethrough and into the sill assembly 20.

The jamb support extensions 190 are also secured to respective jamb members 14 by a fastener. In the illustrated embodiment, an opening 180 is provided through the support surface 158 that allows a fastener to extend therethrough and into the respective jamb member 14.

As noted above, the jamb supports 22 have an interlocking structure 82, in the form of a recess, formed therewith. The jamb support extension 190 has an interlocking structure 182, in the form of an extension, formed therewith. In use, the extension 182 of the jamb support extension 190 is inserted into the recess 82 of the jamb support 22 to interlock the jamb support extension 190 with the jamb support 22 in cooperating relation. It should be understood that the interlocking structures 82, 182 on the jamb support 22 and jamb support extension 190 may have any other suitable configuration than that illustrated. Moreover, the jamb supports 22 and jamb support extensions 190 may be interlocked or connected with one another in any other suitable manner.

The jamb support extension 190 also includes seal members 192 that overlap the jamb support 22 in use to seal the edges between the jamb support extension 190 and the jam support 22. Additionally, the jamb support extension 190 may include a groove 194 in the connecting wall opposite the interlocking structure 182. The groove 194 may be provided for aesthetic reasons to match the profile of the jamb members 14. Furthermore, the groove 194 can be used as an alignment guide for brickmold and other trim pieces.

The jamb support extensions 190 may be formed with a similar material, e.g., synthetic material, and by a similar process, e.g., molding, as the jamb supports 22.

FIG. 45 illustrates the jamb support 22 attached to the sill assembly 20 and aligned with the jamb support extension 190. FIG. 46 illustrates the jamb support 22 attached to the sill assembly 20 and interlocked with the jamb support extension 190.

FIGS. 26-33 illustrate another embodiment of a jamb support extension 290 that may be connected with an associated jamb support 22. The jamb support extensions 290 are thinner than the jamb support extensions 190 so as to accommodate less wide door jambs 14 and/or less wide thresholds 26 than the jamb support extensions 190.

Each jamb support extension 290 includes an outer side wall 250, an inner side wall 252, and connecting walls 254, 255 that interconnect the outer and inner side walls 250, 252. The walls 250, 252, 254, 255 support a base wall 256 that provides a substantially flat jamb support surface 258 upon which the corresponding vertically extending jamb member 14 rests. In use, the jamb support surface 258 of the jamb support extension 290 is substantially flush with the jamb support surface 58 of the jamb support 22. Also, a connecting portion 262 extends outwardly from the inner side wall 252 to support a portion of the base wall 256 and jamb support surface 258 thereof.

The inner side wall 252 of each jamb support extension 290 is structured to cover an extended open end of the sill assembly 20. Specifically, the inner side wall 252 includes a sill engaging surface 264 that engages the sill assembly 20. Also, as best shown in FIGS. 26 and 30, lower edges 266 of the connecting portion 262 are suitably angled so as to accommodate the incline of the inclined threshold 26.

Since the jamb support extension 290 is relatively thin, fastener receiving openings are not provided through either of the sill engaging surface 264 or the jamb support surface 258 for securing the jamb support extension 290 to the sill assembly 20 and the respective jamb member 14, respectively.

The jamb support extension 290 has an interlocking structure 282, in the form of an extension, formed therewith. In use, the extension 282 of the jamb support extension 290 is inserted into the recess 82 of the jamb support 22 to interlock the jamb support extension 290 with the jamb support 22 in cooperating relation. It should be understood that the interlocking structures 82, 282 on the jamb support 22 and jamb support extension 290 may have any other suitable configuration than that illustrated. Moreover, the jamb supports 22 and jamb support extensions 290 may be interlocked or connected with one another in any other suitable manner.

The jamb support extension 290 also includes seal members 292 that overlap the jamb support 22 in use to seal the edges between the jamb support extension 290 and the jam support 22. Additionally, the jamb support extension 290 includes a groove 294, like groove 194, in the connecting wall opposite the interlocking structure 282.

The jamb support extensions 290 may be formed with a similar material, e.g., synthetic material, and by a similar process, e.g., molding, as the jamb supports 22.

As shown in FIG. 34, sealing gaskets 146, 148 are provided between the jamb support extensions 190 and each of the sill assembly 20 and the jamb members 14, respectively, for sealing purposes. Specifically, a sill sealing gasket 146 is provided between the jamb support extension 190 and the respective end of the sill assembly 20 and a jamb sealing gasket 148 is provided between the jamb support extension 190 and the respective jamb member 22. As shown in FIGS. 37 and 38, the sill sealing gasket 146 has a shape that corresponds to a shape of the sill engaging surface 164 of the inner side wall 152. Also, the sill sealing gasket 146 has fastener receiving openings 186 therethrough, e.g., two openings, that align with the openings 168 formed through the sill engaging surface 164. As shown in FIGS. 35 and 36, the jamb sealing gasket 148 has a shape that corresponds to a shape of the jamb support surface 158 of the base wall 156. Also, the jamb sealing gasket 148 has a fastener receiving opening 188 therethrough that aligns with the opening 180 formed through the jamb support surface 158. The gaskets 146, 148 may be secured to the associated surface of the jamb support extension 190 in any suitable manner, e.g., an adhesive. Further, the gaskets 146, 148 may be constructed of any suitable sealing material, e.g., closed cell polyethylene.

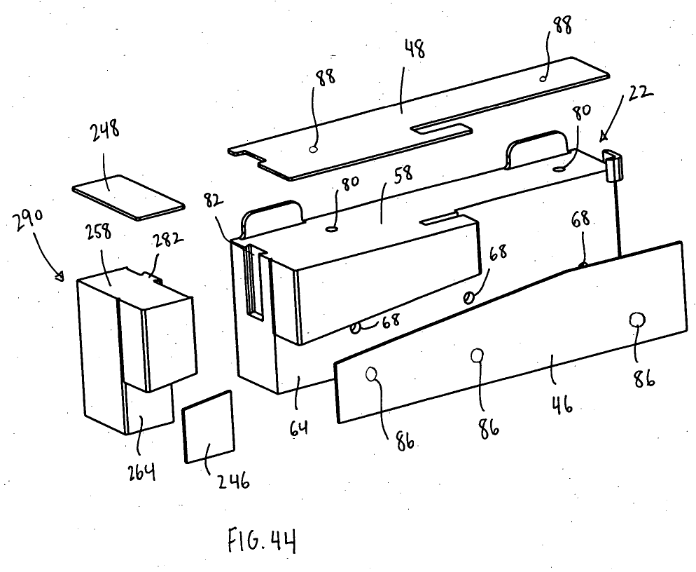

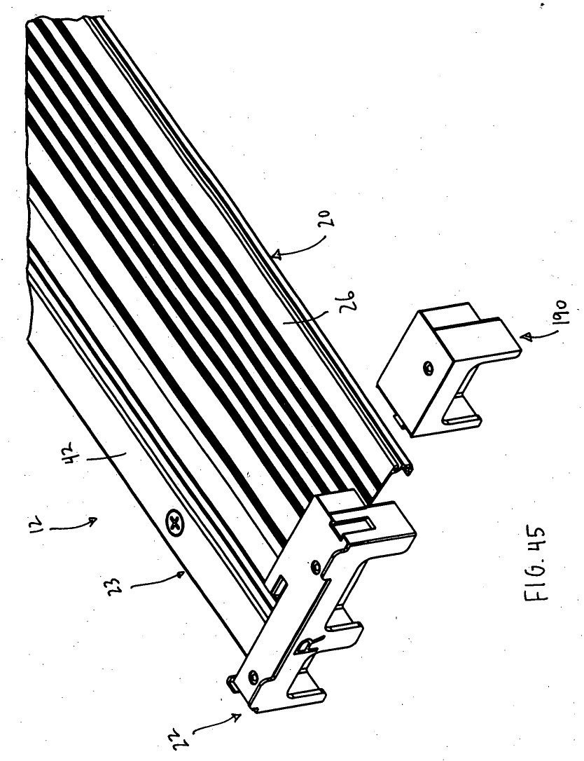

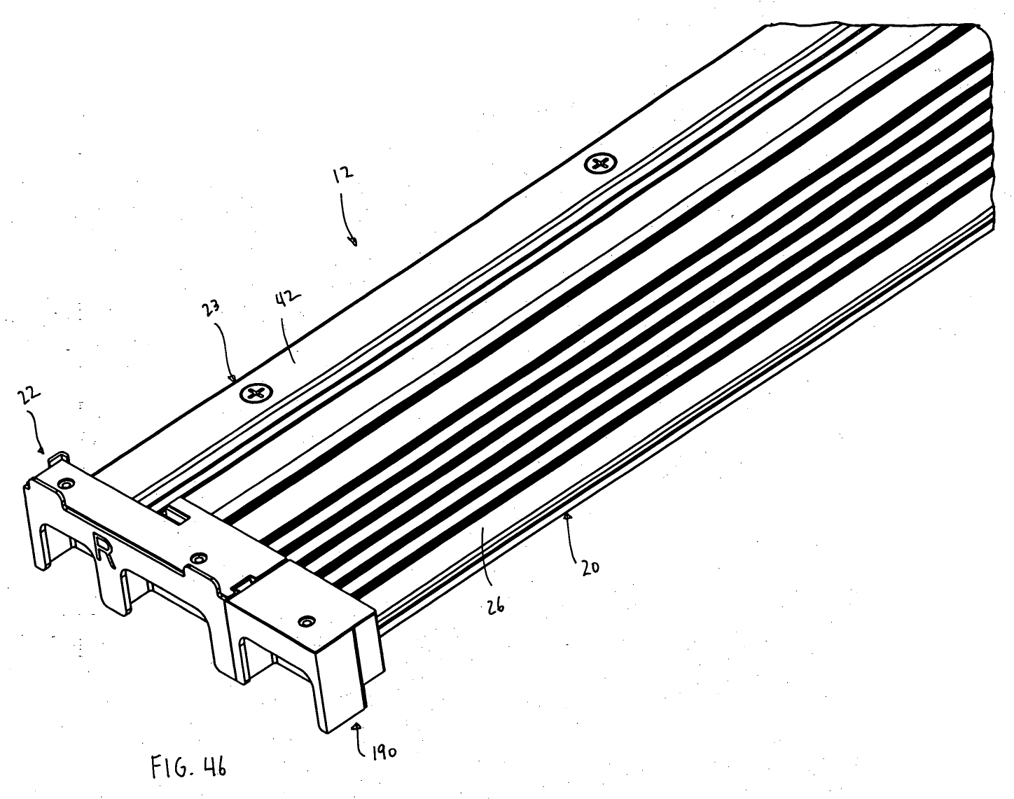

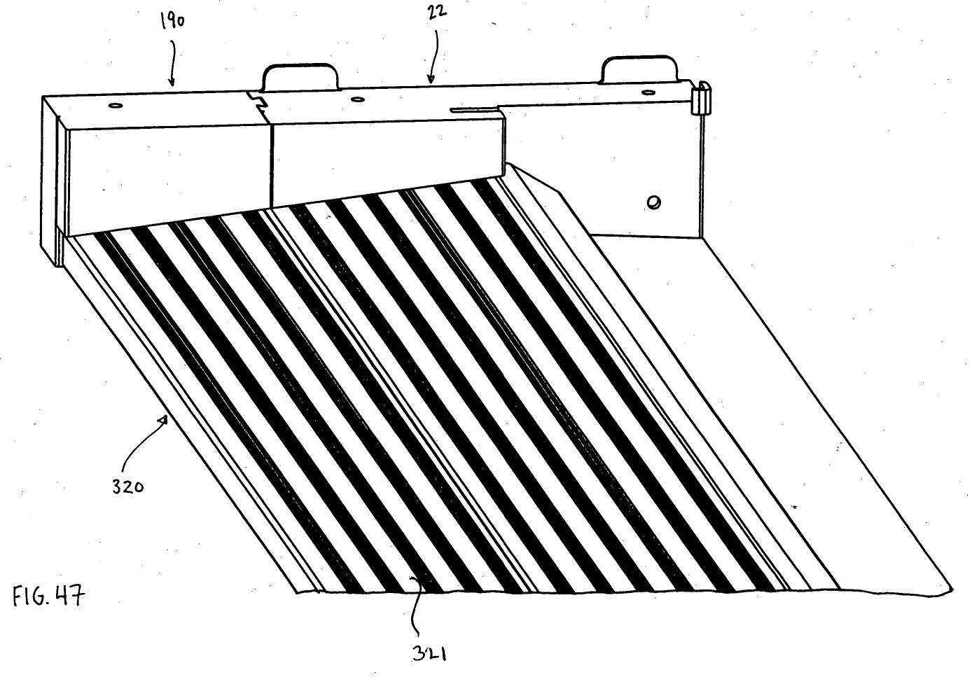

As shown in FIG. 39, sealing gaskets 246, 248 are also provided between the jamb support extensions 290 and each of the sill assembly 20 and the jamb members 14, respectively, for sealing purposes. Specifically, a sill sealing gasket 246 is provided between the jamb support extension 290 and the respective end of the sill assembly 20 and a jamb sealing gasket 248 is provided between the jamb support extension 290 and the respective jamb member 14. As shown in FIGS. 42 and 43, the sill sealing gasket 246 has a shape that corresponds to a shape of the sill engaging surface 264 of the inner side wall 252. As shown in FIGS. 40 and 41, the jamb sealing gasket 248 has a shape that corresponds to a shape of the jamb support surface 258 of the base wall 256. The gaskets 246, 248 may be secured to the associated surface of the jamb support extension 290 in any suitable manner, e.g., an adhesive. Further, the gaskets 246, 248 may be constructed of any suitable sealing material, e.g., closed cell polyethylene. FIG. 44 illustrates the jamb support 22 (with associated gaskets 46, 48) aligned with the jamb support extension 290 (with associated gaskets 246, 248).

In the illustrated embodiment, the jamb supports 22 are attached to a sill assembly 20 having a high profile. However, the jamb supports 22 may be attached to a sill assembly that is suitably modified to provide a low profile wherein the overall height is lower than that of the high profile sill assembly. Also, it should be understood that the jamb supports 22 may be adapted for use with any suitable sill assembly, including both inswing and outswing sill assemblies. For example, FIG. 47 illustrates jamb supports 22 with jamb support extensions 190 attached to a sill assembly 320 for use in an out swinging door. In this arrangement, the sill assembly includes a threshold 321 that is positioned to be located on the interior of the building or structure.

It can thus be appreciated that the aspects of the present invention have been fully and effectively accomplished. The foregoing specific embodiments have been provided to illustrate the structural and functional principles of the present invention, and are not intended to be limiting. To the contrary, the present invention is intended to encompass all modifications, alterations, and substitutions within the spirit and scope of the appended claims.

1. A sill assembly for a doorjamb assembly, wherein the door jamb assembly includes a pair of vertically extending jamb members, a header structure, and at least one door, the threshold and door sill assembly comprising:
a sill assembly including a sill base and a threshold connected to the sill base, the threshold providing an inclined top surface; and
a pair of jamb supports, one of the jamb supports being attached to one end of the sill assembly and the other of the jamb supports being attached to an opposite end of the sill assembly, wherein the jamb supports protrude outwardly from the sill assembly and provide substantially flat jamb support surfaces that engage and support a respective one of the jamb members, wherein each jamb support having a side profile that is complimentary with the end profile of the sill base and the threshold such that a portion of the jamb support extends over the top of the threshold, wherein each jamb support having at least one upwardly extending flange for orienting the jamb member or the jamb support.

2. The sill assembly according to claim 1, wherein each jamb support includes an outer side wall and an inner side wall that are laterally spaced apart from one another, the inner side wall being attached to the respective end of the sill assembly by one or more fasteners, and wherein the outer side wall includes at least one opening that allows access to the inner side wall.

3. The sill assembly according to claim 1, wherein sealing gaskets are provided between the jamb supports and each of the sill assembly and jamb member, respectively.

4. The sill assembly according to claim 1, wherein the at least one upwardly extending flange includes a corner flange which extends partially along one side and one end of the jamb support.

5. The sill assembly according to claim 1, further comprising a pair of jamb support extensions that are interlocked with a respective one of the jamb supports.

6. The sill assembly according to claim 5, wherein each jamb support extension includes an outer side wall and an inner side wall that are laterally spaced apart from one another, the inner side wall being attached to the respective end of the sill assembly by one or more fasteners, and wherein the outer side wall includes at least one opening that allows access to the inner side wall.

7. The sill assembly according to claim 5, wherein each jamb support includes an interlocking structure that interlocks with an interlocking structure provided on the each of the jamb support extensions in cooperating relation.

8. The sill assembly according to claim 7, wherein the interlocking structure of the jamb support is a recess and the interlocking structure of the jamb support extension is an extension.

9. The sill assembly according to claim 5, wherein the jamb support extensions provides jamb support surfaces that are substantially flush with the jamb support surfaces of the jamb supports when interlocked therewith.

10. The sill assembly according to claim 5, wherein sealing gaskets are provided between the jamb support extensions and each of the sill assembly and jamb member, respectively.

11. A jamb support assembly for attachment to opposite ends of a door sill assembly for a doorjamb assembly for securing the sill assembly to respective jambs members of a frame, the jamb support assembly comprising:
a pair of jamb supports, one of the jamb supports being attached to one end of the sill assembly and the other of the jamb supports being attached to an opposite end of the sill assembly, wherein the jamb supports protrude outwardly from the sill assembly and provide substantially flat jamb support surfaces that engage and support a respective one of the jamb members,
wherein each jamb support having at least one upwardly extending flange adapted to orient the jamb members.

12. The jamb support assembly according to claim 1 1, wherein each jamb support includes an outer side wall and an inner side wall that are laterally spaced apart from one another, the inner side wall being attached to the respective end of the sill assembly by one or more fasteners, and wherein the outer side wall includes at least one opening that allows access to the inner side wall.

13. The jamb support assembly according to claim 11, wherein the at least one upwardly extending flange includes a corner flange, which extends partially along one side and one end of the jamb support.

14. The jamb support assembly according to claim 11, further comprising a jamb support extension that is interlocked with the jamb support.

15. The jamb support assembly according to claim 14, wherein each jamb support extension includes an outer side wall and an inner side wall that are laterally spaced apart from one another, the inner side wall being attached to the respective end of the sill assembly by one or more fasteners, and wherein the outer side wall includes at least one opening that allows access to the inner side wall.

16. The jamb support assembly according to claim 14, wherein each jamb support includes an interlocking structure that interlocks with an interlocking structure provided on the each of the jamb support extensions in cooperating relation.

17. The jamb support assembly according to claim 16, wherein the interlocking structure of the jamb support is a recess and the interlocking structure of the jamb support extension is an extension.

18. The jamb support assembly according to claim 14, wherein the jamb support extensions provides jamb support surfaces that are substantially flush with the jamb support surfaces of the jamb supports when interlocked therewith.
